(19) United States
(12) Patent Application Publication
(10) Pub. No.: US 2023/0314846 A1
(43) Pub. Date: Oct. 5, 2023

(54) CONFIGURABLE MULTIFUNCTIONAL DISPLAY PANEL

(71) Applicant: Meta Platforms Technologies, LLC, Menlo Park, CA (US)

(72) Inventors: Zhimin SHI, Bellevue, WA (US); Changwon JANG, Seattle, WA (US); Afsoon JAMALI, Issaquah, WA (US)

(73) Assignee: Meta Platforms Technologies, LLC, Menlo Park, CA (US)

(21) Appl. No.: 17/710,383

(22) Filed: Mar. 31, 2022

(51) Int. Cl. G02F 1/01; G02B 27/01; G06F 1/16

(52) U.S. Cl. CPC G02F 1/0102; G02B 27/0172; G02F 1/0136; G06F 1/163; G02B 2027/0178; G02F 2203/07; G02F 2203/50

(57) ABSTRACT

According to examples, apparatuses, systems, and methods for reconfiguring a multifunctional display panel are described. A display panel may include a polarization-dependent light modulation layer to modulate at least a phase of an incident light and to generate a modulated light. The modulated light is a function of at least one of a polarization state, a phase, or an amplitude of the incident light. One or more switchable polarization optical elements are operatively coupled to the polarization-dependent optical modulation layer. The one or more switchable polarization optical elements are to select an operational to mode of the display panel by adjusting the polarization state of the incident light to select the modulation applied to the incident light to generate the modulated light.

### TECHNICAL FIELD

This patent application relates generally to display panels, and more specifically, to apparatuses, systems, and methods using a reconfigurable multifunctional display panel.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, many providers have endeavored to offer various forms of wearable display systems. One such example be a head-mounted device (HMD), such as a wearable eyewear, a wearable headset, or eyeglasses. In some examples, the head-mounted device (HMD) may project or direct light to form a first image and a second image, and with these images, to generate “binocular” vision for viewing by a user.

Holography uses light interference patterns to form three-dimensional (3D) images. Light can be modulated according to a pattern output by an algorithm to produce a hologram. Complex light modulation involves modulating both the amplitude and the phase of a light beam.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIG. 3 illustrates a perspective view of a near-eye display in the form of a pair of glasses, according to an example.

FIG. 4 illustrates a diagram of a configurable multifunctional display panel, according to an example.

FIG. 5 illustrates a diagram of an example configurable multifunctional display panel implementing the configurable multifunctional display panel of FIG. 4, according to an example.

FIG. 6 illustrates a diagram of a configurable multifunctional display panel, according to an example.

FIG. 7 illustrates a diagram of an example configurable multifunctional display panel implementing the configurable multifunctional display panel of FIG. 6, according to an example.

FIG. 8 illustrates a diagram of a configurable multifunctional display panel, according to an example.

FIG. 9 illustrates a diagram of an example configurable multifunctional display panel implementing the configurable multifunctional display panel of FIG. 8, according to an example.

FIG. 10 illustrates a diagram of a configurable multifunctional display panel, according to an example.

FIG. 11 illustrates a diagram of an example configurable multifunctional display panel implementing the configurable multifunctional display panel of FIG. 10, according to an example.

FIG. 12 illustrates a diagram of a configurable multifunctional display panel, according to an example.

FIG. 13 illustrates a diagram of an example configurable multifunctional display panel implementing the configurable multifunctional display panel of FIG. 12, according to an example.

FIG. 14 illustrates a diagram of a configurable multifunctional display panel, according to an example.

FIG. 15 illustrates a diagram of an example configurable multifunctional display panel implementing the configurable multifunctional display panel of FIG. 14, according to an example.

FIG. 16 is a flow diagram illustrating an example method for modulating light, according to various examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on. The terms “connected” and “coupled” are not limited to physical or mechanical connections or couplings and can include electrical connections or couplings, whether direct or indirect. The terms “circuit” and “circuitry” and “controller” may include a single component or a plurality of components that are active and/or passive and that are connected or otherwise coupled to provide the described function. The term “operatively coupled” includes wired coupling, wireless coupling, magnetic coupling, radio communication, software-based communication, and/or combinations thereof.

Dual-layer liquid crystal display (LCD) panels may modulate the amplitude and phase of a light (e.g., a light field) to achieve complex light modulation. Such display panels may implement high-performance holographic displays to generate three-dimensional (3D) scenes. High dynamic range (HDR) display panels may be capable of providing high contrast in a generated scene. This may improve the user experience. However, dual-layer liquid crystal display panels and high dynamic range display panels may be implemented using various manufacturing processes. These types of panels may be implemented for various purposes. In view of the manufacturing processes involved in producing dual-layer liquid crystal display panels and high dynamic range display panels, the two types of display panels generally have different layered designs and cannot be reconfigured into each other after being assembled.

Disclosed herein are systems, methods, and apparatuses that may configure a display panel to operate in various operational modes to provide multiple functions. In various examples, a dual-layer light modulation panel may dynamically switch between a complex field modulation mode and a high dynamic range (HDR) amplitude modulation mode. In some examples, a light modulation layer may have a polarization-dependent continuously tunable phase response for transmitted light. For example, the phase response of the light modulation layer to a given polarization state may be adjustable smoothly across a range or with a relatively fine granularity, e.g., 4-, 8- or 12-bit resolution. One or more (e.g., two) polarization optics and polarizers may be located on one or both sides of the light modulation layer. For example, for a reflection-type example, polarization optics and a polarizer may be located on one side of the light modulation layer. As another example, for a transmission-type example, polarization optics and polarizers may be located on both sides of the light modulation layer. Operation of the light modulation layer may be controlled (e.g., switched) by selecting different polarization states of light that passes through the light modulation layer. In some examples, a second light modulation layer may be omitted. A single-layer panel may be dynamically configured between a phase modulation mode, e.g., for holography, and an amplitude modulation mode, e.g., for non-holographic display operation.

According to various examples, apparatuses, systems, and methods for reconfiguring a multifunctional display panel are described. A display panel may include a polarization-dependent light modulation layer to modulate at least a phase of an incident light and to generate a modulated light. The modulated light is a function of at least one of a polarization state, a phase, or an amplitude of the incident light. One or more switchable polarization optical elements are operatively coupled to the polarization-dependent optical modulation layer. The one or more switchable polarization optical elements are to select an operational mode of the display panel by adjusting the polarization state of the incident light to select the modulation applied to the incident light to generate the modulated light.

Various examples described herein may provide the capability to operate a display in different operational modes to meet different types of user experience demands. For example, a high dynamic range mode may provide high visual contrast and may increase user satisfaction, for example, for home theatre applications. A complex field modulation mode may provide the capability to realize three-dimensional (3D) holographic scenes. Further, due to the high level of integration of two light modulation panels and switchable polarization optics elements, the display panel may be manufactured with a compact form factor. In addition, the manufacturing process may be compatible with thin film transistor (TFT), liquid crystal on silicon (LCOS), and/or other display panel technologies or mass production technologies.

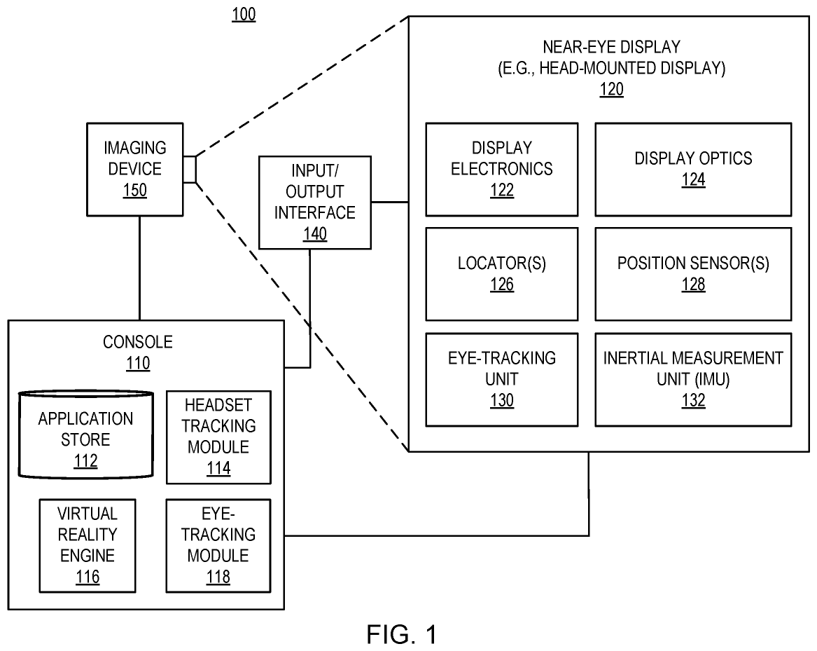

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eyebox, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular HMD) or both eyes (for binocular HMDs). Also, as used herein, an “eyebox” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eyebox.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

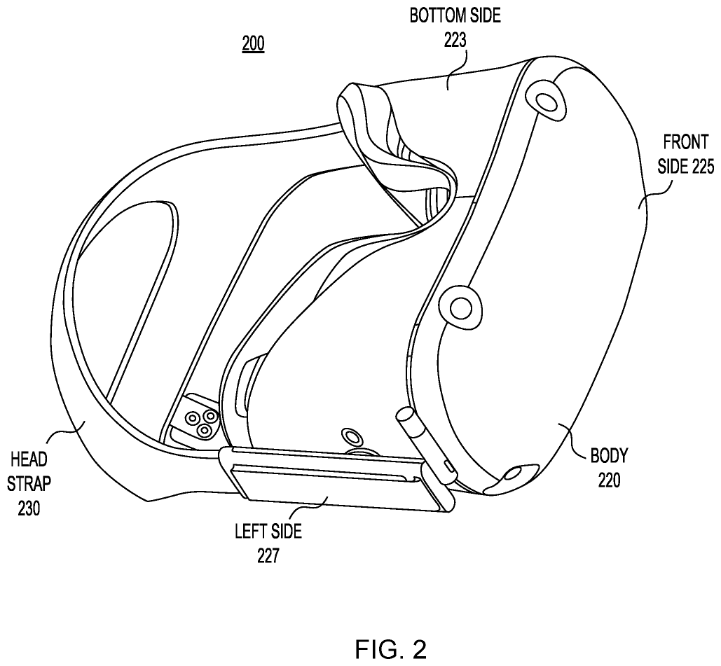

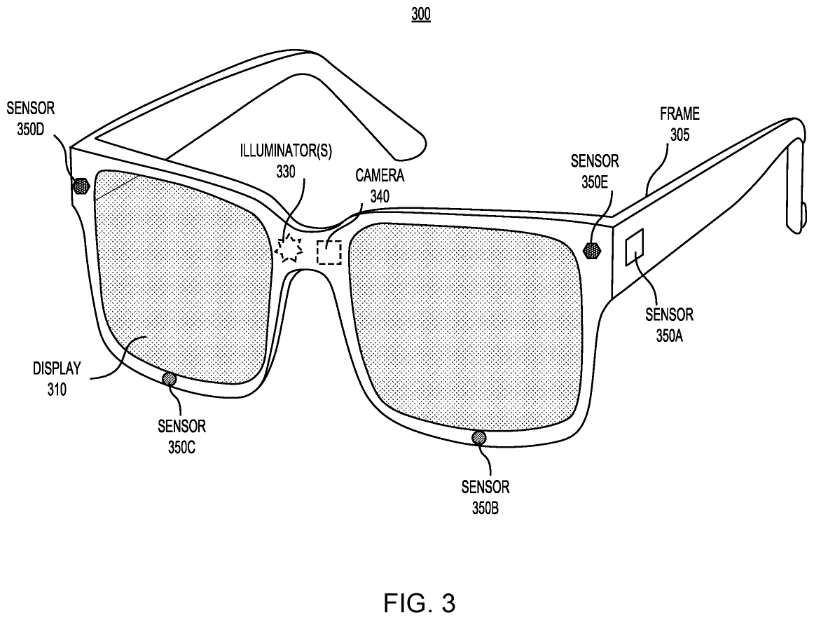

In some examples, the near-eye display 120 may be implemented in any suitable form-factor, including a HMD, a pair of glasses, or other similar wearable eyewear or device. Examples of the near-eye display 120 are further described below with respect to FIGS. 2 and 3. Additionally, in some examples, the functionality described herein may be used in a HMD or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye-tracking unit 130. In some examples, the near-eye display 120 may also include one or more locators 126, one or more position sensors 128, and an inertial measurement unit (IMU) 132. In some examples, the near-eye display 120 may omit any of the eye-tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye-tracking unit 130 may include one or more eye-tracking systems. As used herein, “eye tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye-tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye-tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye-tracking module 118. Based on the received information, the virtual reality engine 116 may determine content to provide to the near-eye display 120 for presentation to the user.

In some examples, the eye-tracking module 118 may receive eye-tracking data from the eye-tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye-tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the HMD device 200 may be a part of a virtual reality (VR) system, an augmented reality (AR) system, a mixed reality (MR) system, another system that uses displays or wearables, or any combination thereof. In some examples, the HMD device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the HMD device 200 for allowing a user to mount the HMD device 200 onto the user's head. For example, the length of the head strap 230 may be adjustable to accommodate a range of user head sizes. In some examples, the HMD device 200 may include additional, fewer, and/or different components.

In some examples, the HMD device 200 may present, to a user, media or other digital content including virtual and/or augmented views of a physical, real-world environment with computer-generated elements. Examples of the media or digital content presented by the HMD device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the HMD device 200.

In some examples, the HMD device 200 may include various sensors (not shown), such as depth sensors, motion sensors, position sensors, and/or eye tracking sensors. Some of these sensors may use any number of structured or unstructured light patterns for sensing purposes. In some examples, the HMD device 200 may include an input/output interface 140 for communicating with a console 110, as described with respect to FIG. 1. In some examples, the HMD device 200 may include a virtual reality engine (not shown), but similar to the virtual reality engine 116 described with respect to FIG. 1, that may execute applications within the HMD device 200 and receive depth information, position information, acceleration information, velocity information, predicted future positions, or any combination thereof of the HMD device 200 from the various sensors.

In some examples, the information received by the virtual reality engine 116 may be used for producing a signal (e.g., display instructions) to the one or more display assemblies. In some examples, the HMD device 200 may include locators (not shown), but similar to the virtual locators 126 described in FIG. 1, which may be located in fixed positions on the body 220 of the HMD device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

FIG. 3 is a perspective view of a near-eye display 300 in the form of a pair of glasses (or other similar eyewear), according to an example. In some examples, the near-eye display 300 may be a specific example of near-eye display 120 of FIG. 1, and may be to operate as a virtual reality display, an augmented reality display, and/or a mixed reality display.

In some examples, the near-eye display 300 may include a frame 305 and a display 310. In some examples, the display 310 may be to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc.

In some examples, the near-eye display 300 may further include various sensors 350a, 350b, 350c, 350d, and 350e on or within a frame 305. In some examples, the various sensors 350a-350e may include any number of depth sensors, motion sensors, position sensors, inertial sensors, and/or ambient light sensors, as shown. In some examples, the various sensors 350a-350e may include any number of image sensors to generate image data representing different fields of views in one or more different directions. In some examples, the various sensors 350a-350e may be used as input devices to control or influence the displayed content of the near-eye display 300, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar application.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminator(s) 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications.

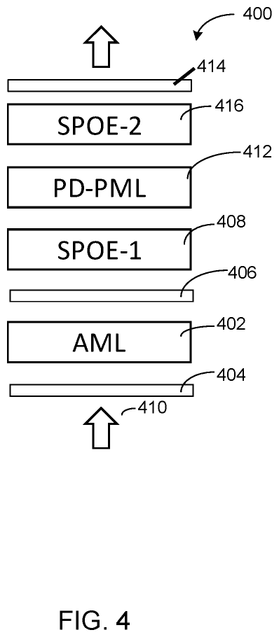

FIG. 4 illustrates a diagram of a configurable multifunctional display panel 400, according to an example. FIG. 4 illustrates selected functional components of the configurable multifunctional display panel 400. For simplicity, some material layers, such as a spacer, electrodes, static polarization optics, a micro-lens array, and the like, are not shown in FIG. 4.

In some examples, the configurable multifunctional display panel 400 may include an amplitude modulation layer 402. An entrance polarizer 404 may be located on a first side of the amplitude modulation layer 402. An intermediate polarizer 406 may be located on a second side of the amplitude modulation layer 402. A switchable polarization optical element (SPOE) 408 may selectively modify a polarization state of an incident light field 410.

In some examples, a polarization-dependent phase modulation layer 412 may modify the phase of the light field output by the switchable polarization optical element 408. The polarization-dependent phase modulation layer 412 may have a continuously tunable phase response that is dependent on a polarization state of an input light field to the polarization-dependent phase modulation layer 412. For example, the phase response to a horizontally polarized light field may be different from the phase response to a vertically polarized light field.

In some examples, an exit polarizer 414 may be set to pass light having a given polarization state. A switchable polarization optical element 416 may modify the polarization state of the light field output by the polarization-dependent phase modulation layer 412, e.g., to align the light polarization with the exit polarizer 414 for the phase modulation mode, and to effectively control the power level of the light field output by the exit polarizer 532 in the amplitude modulation mode.

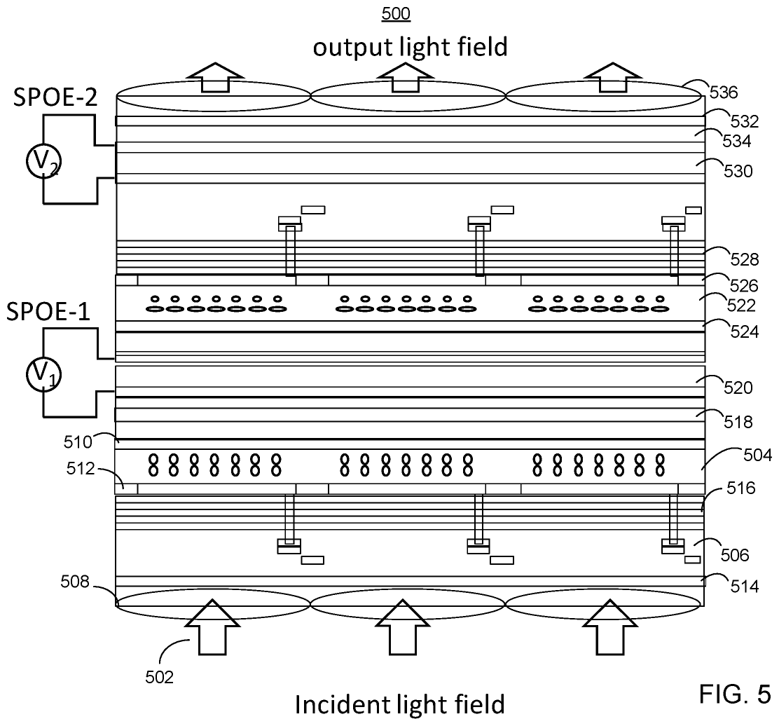

FIG. 5 illustrates a diagram of an example configurable multifunctional display panel 500 implementing the configurable multifunctional display panel 400 of FIG. 4, according to an example. An incident light field 502 may impinge upon an amplitude modulation layer 504. The amplitude modulation layer 504 may be implemented using any of a variety of materials, including, but not limited to, one or more of the following: liquid crystal under various display modes (e.g., twisted-nematic (TN), in-plane-switching (IPS), fringe field switching (FFS), etc.), active electro-optic polymers, semiconductors, doped materials, active metamaterials (e.g., composite materials having a feature size comparable to or smaller than an operating optical wavelength), and/or optical movable microelectromechanical systems (MEMS) structures. Reflective layers may be added to the sides of the amplitude modulation layer 504 to form an optical resonance cavity to enhance light-matter interaction.

In some examples, the amplitude modulation layer 504 may be supported on a substrate 506. A focusing element array 508 may focus light onto openings of the amplitude modulation layer 504 to increase transmission. The focusing element array 508 may include one or more of a micro-lens array (MLA), holographic-optic elements (HOE), diffractive-optic elements (DOE), and/or meta-surface elements or arrays.

Operation of the amplitude modulation layer 504 may be controlled by electrodes. For example, a common electrode layer 510 and pixelated electrodes 512 may allow individual pixels of the amplitude modulation layer 504 to be controlled. The common electrode layer 510 and the pixelated electrodes 512 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, an entrance polarizer 514 may seta polarization state of the incident light field 502. For example, the entrance polarizer 514 may set the polarization state of the incident light field 502 to match an input polarization state that the amplitude modulation layer 504 is to receive (e.g., a polarization state PS1 corresponding to 45-degree linear polarization). In some examples, an anti-reflection film 516 reduces the amount of unwanted or extraneous reflected light that impinges upon the amplitude modulation layer 504. Reducing the amount of unwanted or extraneous reflected light that impinges upon the amplitude modulation layer 504 may reduce the incidence of ghost optical paths and may improve contrast performance, light efficiency, and other performance characteristics of the display panel.

An intermediate polarizer 518 may set a polarization state of the light field output by the amplitude modulation layer 504. The light field output by the intermediate polarizer 518 may have a polarization state that is different from the incident light field 502. For example, the light field output by the intermediate polarizer 518 may have a polarization state PS2 corresponding to 135-degree linear polarization.

In some examples, a switchable polarization optical element 520 may be to place the configurable multifunctional display panel 500 in one of multiple modes of operation. The switchable polarization optical element 520 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 520 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, a polarization-dependent phase modulation layer 522 modulates at least one of a phase or an amplitude of the light field output by the switchable polarization optical element 520 as a function of its polarization state. The polarization state may correspond to an operational mode of the configurable multifunctional display panel 500. For example, one polarization state may correspond to a complex modulation mode, while another polarization state may correspond to a high dynamic range modulation mode.

Operation of the polarization-dependent phase modulation layer 522 may be controlled by electrodes. For example, a common electrode layer 524 and pixelated electrodes 526 may allow individual pixels of the polarization-dependent phase modulation layer 522 to be controlled. The common electrode layer 524 and the pixelated electrodes 526 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides. In some examples, an anti-reflection film 528 reduces the amount of undesired or extraneous reflected light that is output by the polarization-dependent phase modulation layer 522. Reducing the amount of undesired or extraneous reflected light output by the polarization-dependent phase modulation layer 522 may reduce the incidence of ghost optical paths, potentially improving contrast performance, light efficiency, and other performance characteristics of the display panel.

In some examples, a switchable polarization optical element 530 may be to place the configurable multifunctional display panel 500 in one of multiple modes of operation. The switchable polarization optical element 530 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 530 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, an exit polarizer 532 may be set to pass light having a given polarization state. The switchable polarization optical element 530 may modify the polarization state of the light field output by the polarization-dependent phase modulation layer 522, e.g., to align the light polarization with the exit polarizer 532 for the phase modulation mode, and to effectively control the power level of the light field output by the exit polarizer 532 in the amplitude modulation mode. In some examples, the exit polarizer 532 is supported on a substrate layer 534. A focusing element array 536 may focus light emitted by the exit polarizer 532. The focusing element array 536 may include one or more of a micro-lens array (MLA), holographic-optic elements (HOE), diffractive-optic elements (DOE), and/or meta-surface elements or arrays.

The configurable multifunctional display panel 500 may be operated in a first mode corresponding to a base setting. In the base setting, the amplitude modulation layer 504 may be set to receive an incident light field having an input polarization state PS1 (e.g., 45-degree polarization). The intermediate polarizer 518 may be set to output a light field having a polarization state PS2 (e.g., 135-degree polarization). In some examples, the entrance polarizer 514 may set the input polarization state to PS1. In some examples, the entrance polarizer 514 may be omitted.

In the base setting, the polarization-dependent phase modulation layer 522 may modify the phase of the light with a polarization state PS3, which may correspond to a horizontal polarization state. The polarization-dependent phase modulation layer 522 may have a different phase response to an orthogonal polarization state PS4, which may correspond to a vertical polarization state. The exit polarizer 532 may be set to pass a polarization state PS5, which may correspond to a horizontal polarization state.

The configurable multifunctional display panel 500 may be operated in a second mode corresponding to a complex modulation mode. The complex modulation mode may be employed in holography. In the complex modulation mode, the switchable polarization optical element 520 may be set to a first mode (e.g., SPOE-1-Mode-1) such that the polarization state of light is modified from the polarization state PS2 (e.g., 135-degree linear polarization) to the polarization state PS3 (e.g., horizontal polarization). The switchable polarization optical element 530 may be set to a first mode (e.g., SPOE-2-Mode-1) such that the polarization state of light output by the polarization-dependent phase modulation layer 522 is set to have the polarization state PS5 (e.g., horizontal polarization).

The configurable multifunctional display panel 500 may be operated in a third mode corresponding to a double amplitude modulation (e.g., high dynamic range) mode. In the double amplitude modulation mode, the switchable polarization optical element 520 may be set to a second mode (e.g., SPOE-1-Mode-2) such that the polarization state of light is modified from the polarization state PS2 (e.g., 135-degree linear polarization) to a polarization state PS6 that has equal power in polarization states PS3 and PS4 (e.g., horizontal polarization and vertical polarization, respectively, or 45-degree linear polarization). The switchable polarization optical element 530 may be set to a second mode (e.g., SPOE-2-Mode-2) such that the polarization state of an input light to the polarization-dependent phase modulation layer 522 having a polarization state PS3 is converted to have a polarization state PS7 that has half of its power in polarization state PS5 (e.g., horizontal polarization) and a different orientation than polarization state PS5. With the switchable polarization optical element 530 set to the second mode, the polarization state of an input light to the polarization-dependent phase modulation layer 522 having a polarization state PS4 is converted to have a polarization state PS8 that has half of its power in polarization state PS5 (e.g., horizontal polarization) and a different orientation than polarization state PS5.

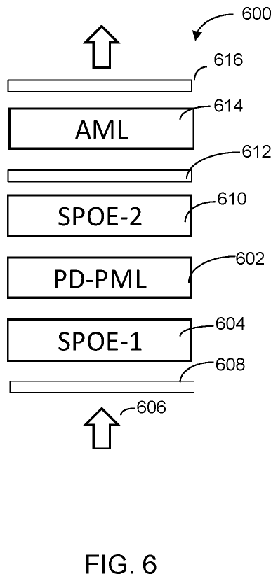

FIG. 6 illustrates a diagram of a configurable multifunctional display panel 600, according to an example. FIG. 6 illustrates selected functional components of the configurable multifunctional display panel 600. For simplicity, some material layers, such as a spacer, electrodes, static polarization optics, a micro-lens array, and the like, are not shown in FIG. 6.

In some examples, the configurable multifunctional display panel 600 may include a polarization-dependent phase modulation layer 602. A switchable polarization optical element 604 may selectively modify a polarization state of an incident light field 606. An entrance polarizer 608 may be located on a first side of the switchable polarization optical element 604. The entrance polarizer 608 may be set to transmit light having a polarization state PS1 (e.g., horizontal polarization). The polarization-dependent phase modulation layer 602 may modify the phase of light having a polarization state PS2 (e.g., horizontal polarization).

In some examples, a switchable polarization optical element 610 converts the polarization state of the light field output by the polarization-dependent phase modulation layer 602. An intermediate polarizer 612 may be set to transmit light having a given polarization state PS4 (e.g., horizontal polarization).

In some examples, an amplitude modulation layer 614 is set to receive light having the polarization state PS4 (e.g., 45-degree linear polarization). The output light field after the intermediate polarizer 612 has a polarization state PS5 (e.g., 135-degree linear polarization). The intermediate polarizer 612 may be set to transmit light having a polarization state PS4 (e.g., 45-degree linear polarization). In some examples, an exit polarizer 616 is set to transmit light having a polarization state PS5 (e.g., 135-degree linear polarization).

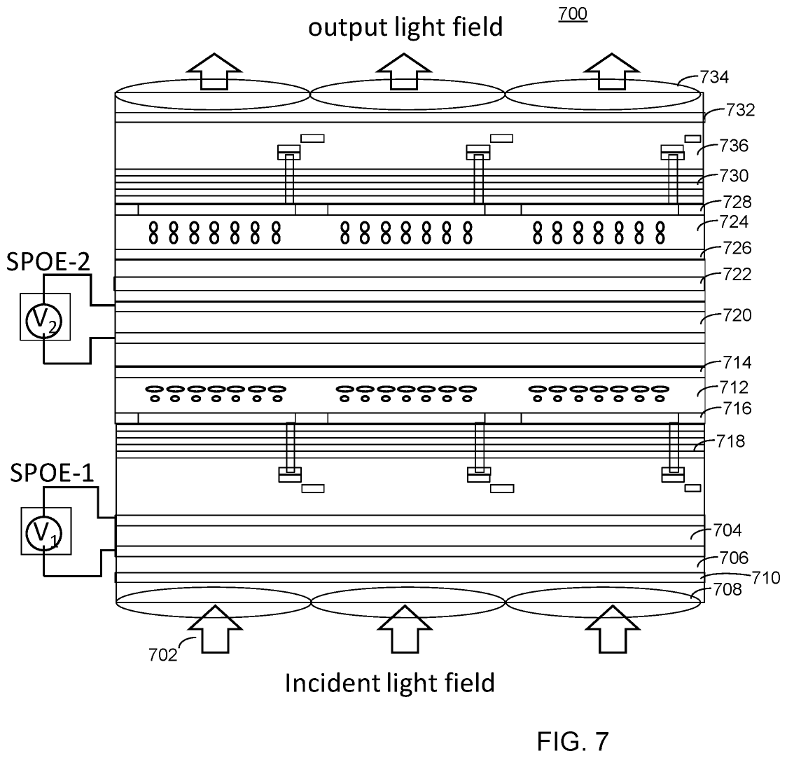

FIG. 7 illustrates a diagram of an example configurable multifunctional display panel 700 implementing the configurable multifunctional display panel 600 of FIG. 6, according to an example. An incident light field 702 may impinge upon a switchable polarization optical element 704. In some examples, the switchable polarization optical element 704 may be to place the configurable multifunctional display panel 700 in one of multiple modes of operation. The switchable polarization optical element 704 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 704 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, the switchable polarization optical element 704 may be supported on a substrate 706. A focusing element array 708 may focus light onto openings of the switchable polarization optical element 704 to increase transmission. The focusing element array 708 may include one or more of a micro-lens array (MLA), holographic-optic elements (HOE), diffractive-optic elements (DOE), and/or meta-surface elements or arrays.

In some examples, an entrance polarizer 710 may set a polarization state of the incident light field 702. For example, the entrance polarizer 710 may set the polarization state of the incident light field 702 into a well-defined polarization state.

In some examples, a polarization-dependent phase modulation layer 712 modulates at least one of a phase or an amplitude of the light field output by the switchable polarization optical element 704 as a function of its polarization state. The polarization state may correspond to an operational mode of the configurable multifunctional display panel 700. For example, one polarization state may correspond to a complex modulation mode, while another polarization state may correspond to a high dynamic range modulation mode.

Operation of the polarization-dependent phase modulation layer 712 may be controlled by electrodes. For example, a common electrode layer 714 and pixelated electrodes 716 may allow individual pixels of the polarization-dependent phase modulation layer 712 to be controlled. The common electrode layer 714 and the pixelated electrodes 716 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides. In some examples, an anti-reflection film 718 reduces the amount of unwanted or extraneous reflected light that is received by the polarization-dependent phase modulation layer 712. Reducing the amount of unwanted or extraneous reflected light received by the polarization-dependent phase modulation layer 712 may reduce the incidence of ghost optical paths, potentially improving contrast performance, light efficiency, and other performance characteristics of the display panel.

In some examples, a switchable polarization optical element 720 converts the polarization state of the light field output by the polarization-dependent phase modulation layer 712. The switchable polarization optical element 720 may be to place the configurable multifunctional display panel 700 in one of multiple modes of operation. The switchable polarization optical element 720 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 720 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

An intermediate polarizer 722 may set a polarization state of the light field output by the polarization-dependent phase modulation layer 712 before it is input to an amplitude modulation layer 724. The light field output after the intermediate polarizer 722 may have a polarization state PS5 (e.g., corresponding to 135-degree linear polarization). The intermediate polarizer 722 may be set to transmit light having a polarization state PS4 (e.g., 45-degree linear polarization).

In some examples, an amplitude modulation layer 724 receives light having a polarization state PS4 (e.g., 45-degree linear polarization). In a mode of operation, the amplitude modulation layer 724 may output a light field having a polarization state PS5 (e.g., 135-degree linear polarization). The amplitude modulation layer 724 may be implemented using any of a variety of materials, including, but not limited to, one or more of the following: liquid crystal under various display modes (e.g., twisted-nematic (TN), in-plane-switching (IPS), fringe field switching (FFS), etc.), active electro-optic polymers, semiconductors, doped materials, active metamaterials (e.g., composite materials having a feature size comparable to or smaller than an operating optical wavelength), and/or optical movable microelectromechanical systems (MEMS) structures. Reflective layers may be added to the sides of the amplitude modulation layer 724 to form an optical resonance cavity to enhance light-matter interaction.

Operation of the amplitude modulation layer 724 may be controlled by electrodes. For example, a common electrode layer 726 and pixelated electrodes 728 may allow individual pixels of the amplitude modulation layer 724 to be controlled. The common electrode layer 726 and the pixelated electrodes 728 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides. In some examples, an anti-reflection film 730 reduces the amount of unwanted or extraneous reflected light that is output by the amplitude modulation layer 724. Reducing the amount of unwanted or extraneous reflected light output by the amplitude modulation layer 724 may reduce the incidence of ghost optical paths, potentially improving contrast performance, light efficiency, and other performance characteristics of the display panel. An exit polarizer 732 may be set to pass light having a polarization state PS5 (e.g., 135-degree linear polarization).

In some examples, a focusing element array 734 may focus light that exits the configurable multifunctional display panel 700. The focusing element array 734 may include one or more of a micro-lens array (MLA), holographic-optic elements (HOE), diffractive-optic elements (DOE), and/or meta-surface elements or arrays. In some examples, the focusing element array 734 may be supported on a substrate 736.

The configurable multifunctional display panel 700 may be operated in a first mode corresponding to a base setting. In the base setting, the entrance polarizer 710 may be set to transmit light having a polarization state PS1 (e.g., horizontal polarization). In some examples, the entrance polarizer 710 may be omitted. The polarization-dependent phase modulation layer 712 may modify the phase of light with a polarization state PS2 (e.g., horizontal polarization) and may have a different phase response (e.g., no response, a much smaller response, or a much larger response) on an orthogonal polarization state PS3 (e.g., vertical polarization). For example, a much smaller or a much larger response may mean that the difference between the phase responses to orthogonal polarization states may be tuned from zero to a maximum value, e.g., larger than 1T. In some examples, the phase response of the polarization-dependent phase modulation layer 712 to a given polarization state (e.g., polarization state PS2 or PS3) may be adjustable smoothly across a range or with a relatively fine granularity, e.g., 4-8- or 12-bit resolution. The amplitude modulation layer 724 may be set to receive light having an input polarization state PS4 (e.g., 45-degree linear polarization). The output after the intermediate polarizer 722 may have polarization state PS5 (e.g., 135-degree linear polarization). In some examples, the intermediate polarizer 722 may be set to transmit light having a polarization state PS4 (e.g., horizontal polarization). In some examples, the exit polarizer 732 is set to transmit light having a polarization state PS5 (e.g., 135 deg linear polarization).

The configurable multifunctional display panel 700 may be operated in a second mode corresponding to a complex modulation mode. The complex modulation mode may be employed in holography. In the complex modulation mode, the switchable polarization optical element 704 may be set to a first mode (e.g., SPOE-1-Mode-1) such that the polarization state of light is modified from the polarization state PS1 (e.g., horizontal polarization) to the polarization state PS2 (e.g., horizontal polarization) before the light enters the polarization-dependent phase modulation layer 712. The switchable polarization optical element 720 may be set to a first mode (e.g., SPOE-2-Mode-1) such that the polarization state of light output by the polarization-dependent phase modulation layer 712 is converted to have the polarization state PS4 (e.g., 45 degree linear polarization).

The configurable multifunctional display panel 700 may be operated in a third mode corresponding to a double amplitude modulation (e.g., high dynamic range) mode. In the double amplitude modulation mode, the switchable polarization optical element 704 may be set to a second mode (e.g., SPOE-1-Mode-2) such that the polarization state of light is modified from the polarization state PS1 (e.g., horizontal polarization) to a polarization state PS6 that has equal power in polarization states PS2 and PS3 (e.g., horizontal polarization and vertical polarization, respectively, or 45-degree linear polarization). The switchable polarization optical element 720 may be set to a second mode (e.g., SPOE-2-Mode-2) such that the polarization state of an input light having a polarization state PS2 is converted to have a polarization state PS6 that has half of its power in polarization state PS4. An input light having a polarization state PS3 is converted to have a polarization state PS7 that has half of its power in polarization state PS4 (e.g., 45 degree linear polarization).

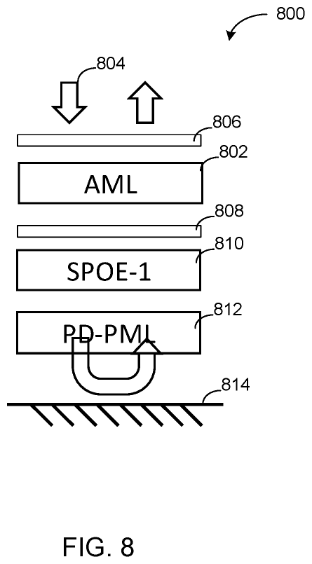

FIG. 8 illustrates a diagram of a configurable multifunctional display panel 800, according to an example. FIG. 8 illustrates selected functional components of the configurable multifunctional display panel 800. For simplicity, some material layers, such as a spacer, electrodes, static polarization optics, a micro-lens array, and the like, are not shown in FIG. 8.

In some examples, the configurable multifunctional display panel 800 may include an amplitude modulation layer 802 that may be to perform amplitude modulation on an incident light field 804. An entrance polarizer 806 may be set to transmit light having a polarization state PS1 (e.g., 45-degree linear polarization) before the light enters the amplitude modulation layer 802. An intermediate polarizer 808 may be set to transmit light output by the amplitude modulation layer 802 having a polarization state PS2 (e.g., 135-degree linear polarization).

In some examples, a switchable polarization optical element 810 may selectively modify a polarization state of the light output by the intermediate polarizer 808 with a polarization state PS3 (e.g., horizontal polarization). In some examples, the configurable multifunctional display panel 800 may include a polarization-dependent phase modulation layer 812. The polarization-dependent phase modulation layer 812 may modify the phase of light having a polarization state PS3 (e.g., horizontal polarization) and may have a different phase response (e.g., no phase response or a very small or very large phase response) on an orthogonal polarization state PS4 (e.g., vertical polarization).

In some examples, when the configurable multifunctional display panel 800 is operated in a complex modulation mode, the polarization state of downward-propagating light is modified from polarization state PS2 to polarization state PS3. The light is reflected off a reflective back panel 814 and maintains the same polarization state PS3 as it passes upward through the polarization-dependent phase modulation layer 812.

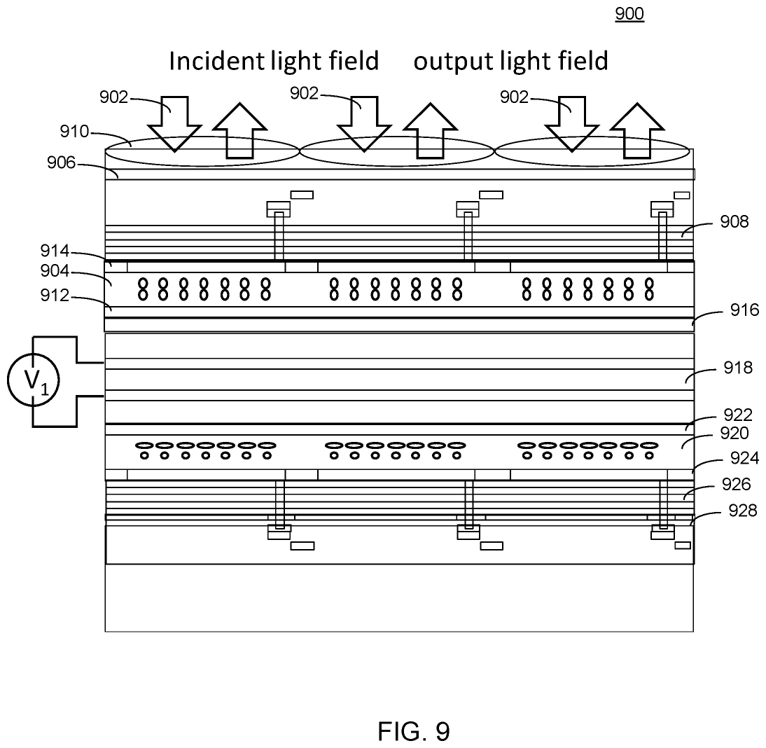

FIG. 9 illustrates a diagram of an example configurable multifunctional display panel 900 implementing the configurable multifunctional display panel 800 of FIG. 8, according to an example. An incident light field 902 may impinge upon an amplitude modulation layer 904. The amplitude modulation layer 904 may be implemented using any of a variety of materials, including, but not limited to, one or more of the following: liquid crystal under various display modes (e.g., twisted-nematic (TN), in-plane-switching (IPS), fringe field switching (FFS), etc.), active electro-optic polymers, semiconductors, doped materials, active metamaterials (e.g., composite materials having a feature size comparable to or smaller than an operating optical wavelength), and/or optical movable microelectromechanical systems (MEMS) structures. Reflective layers may be added to the sides of the amplitude modulation layer 904 to form an optical resonance cavity to enhance light-matter interaction.

An entrance polarizer 906 may be set to transmit light having a polarization state PS1 before the light enters the amplitude modulation layer 904. In some examples, the entrance polarizer 906 may set the polarization state of the incident light field 902. For example, the entrance polarizer 906 may set the polarization state of the incident light field 902 to match an input polarization state that the amplitude modulation layer 904 is to receive (e.g., a polarization state PS1). In some examples, an anti-reflection film 908 reduces the amount of unwanted or extraneous reflected light that impinges upon the amplitude modulation layer 904. Reducing the amount of unwanted or extraneous reflected light that impinges upon the amplitude modulation layer 904 may reduce the incidence of ghost optical paths, potentially improving contrast performance, light efficiency, and other performance characteristics of the display panel.

A focusing element array 910 may focus light onto openings of the amplitude modulation layer 904 to increase transmission. The focusing element array 910 may include one or more of a micro-lens array (MLA), holographic-optic elements (HOE), diffractive-optic elements (DOE), and/or meta-surface elements or arrays.

Operation of the amplitude modulation layer 904 may be controlled by electrodes. For example, a common electrode layer 912 and pixelated electrodes 914 may allow individual pixels of the amplitude modulation layer 904 to be controlled. The common electrode layer 912 and the pixelated electrodes 914 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

An intermediate polarizer 916 may set a polarization state of the light field output by the amplitude modulation layer 904. The light field output by the intermediate polarizer 916 may have a polarization state that is different from the incident light field 902. For example, the light field output by the intermediate polarizer 916 may have a polarization state PS2 corresponding to 135-degree linear polarization.

In some examples, a switchable polarization optical element 918 may be to place the configurable multifunctional display panel 900 in one of multiple modes of operation. The switchable polarization optical element 918 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 918 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, a polarization-dependent phase modulation layer 920 modulates at least one of a phase or an amplitude of the light field output by the switchable polarization optical element 918 as a function of its polarization state. The polarization state may correspond to an operational mode of the configurable multifunctional display panel 900. For example, one polarization state may correspond to a complex modulation mode, while another polarization state may correspond to a high dynamic range modulation mode.

Operation of the polarization-dependent phase modulation layer 920 may be controlled by electrodes. For example, a common electrode layer 922 and pixelated electrodes 924 may allow individual pixels of the polarization-dependent phase modulation layer 920 to be controlled. The common electrode layer 922 and the pixelated electrodes 924 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, the configurable multifunctional display panel 900 may include a high reflection layer 926 and/or a metallic reflective layer 928. When the configurable multifunctional display panel 900 is operated in a complex modulation mode, the polarization state of downward-propagating light may be modified from polarization state PS2 to polarization state PS3. The light is reflected off the high reflection layer 926 and/or the metallic reflective layer 928 and maintains the same polarization state PS3 as it passes upward through the polarization-dependent phase modulation layer 920.

The configurable multifunctional display panel 900 may be operated in a first mode corresponding to a base setting. In the base setting, the amplitude modulation layer 904, the entrance polarizer 906, and the intermediate polarizer 916 may be set for amplitude modulation. The entrance polarizer 906 may be set to transmit light having a polarization state PS1 (e.g., 45-degree linear polarization). The intermediate polarizer may be set to transmit light having a polarization state PS2 (e.g., 135-degree linear polarization).

The polarization-dependent phase modulation layer 920 may modify the phase of light with polarization state PS3 (e.g., horizontal polarization). The polarization-dependent phase modulation layer 920 may have a different phase response (e.g., no response, a very small response, or a very large response) on an orthogonal polarization state PS4 (e.g., vertical polarization).

The configurable multifunctional display panel 900 may be operated in a second mode corresponding to a complex modulation mode. The complex modulation mode may be employed in holography. In the complex modulation mode, the switchable polarization optical element 918 may be set to a first mode (e.g., SPOE-1-Mode-1) such that the polarization state of downward-propagating light is modified from polarization state PS2 to polarization state PS3. The reflected light may maintain the same polarization state PS3 as it is reflected off the back panel and passes through the polarization-dependent phase modulation layer 920 again.

The configurable multifunctional display panel 900 may be operated in a third mode corresponding to a double amplitude modulation (e.g., high dynamic range) mode. In the double amplitude modulation mode, the switchable polarization optical element 918 may be set to a second mode (e.g., SPOE-1-Mode-2) such that the polarization state of light is modified from the polarization state PS2 to a polarization state PS5 that has equal power in polarization states PS3 and PS4 (e.g., horizontal polarization and vertical polarization, respectively, or 45-degree linear polarization).

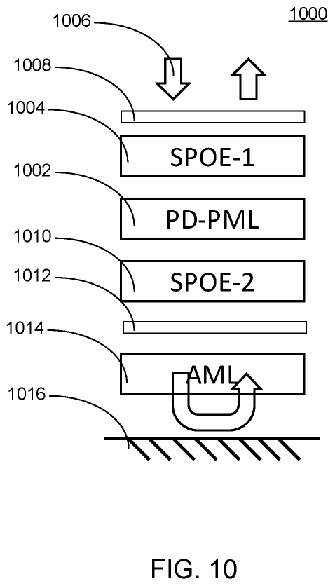

FIG. 10 illustrates a diagram of a configurable multifunctional display panel 1000, according to an example. FIG. 10 illustrates selected functional components of the configurable multifunctional display panel 1000. For simplicity, some material layers, such as a spacer, electrodes, static polarization optics, a micro-lens array, and the like, are not shown in FIG. 10.

In some examples, the configurable multifunctional display panel 1000 may include a polarization-dependent phase modulation layer 1002. A switchable polarization optical element 1004 may selectively modify a polarization state of an incident light field 1006. An entrance polarizer 1008 may be located on a first side of the switchable polarization optical element 1004. The entrance polarizer 1008 may be set to transmit light having a given polarization state PS1 (e.g., horizontal polarization). The polarization-dependent phase modulation layer 1002 may modify the phase of light having a polarization state PS2 (e.g., horizontal polarization).

In some examples, a switchable polarization optical element 1010 converts the polarization state of the light field output by the polarization-dependent phase modulation layer 1002. An intermediate polarizer 1012 may be set to transmit light having a given polarization state PS4 (e.g., horizontal polarization).

In some examples, an amplitude modulation layer 1014 and the intermediate polarizer 1012 modify the intensity of light of polarization state PS4 when the light reflects off a reflective back panel 1016 and passes back through the amplitude modulation layer 1014.

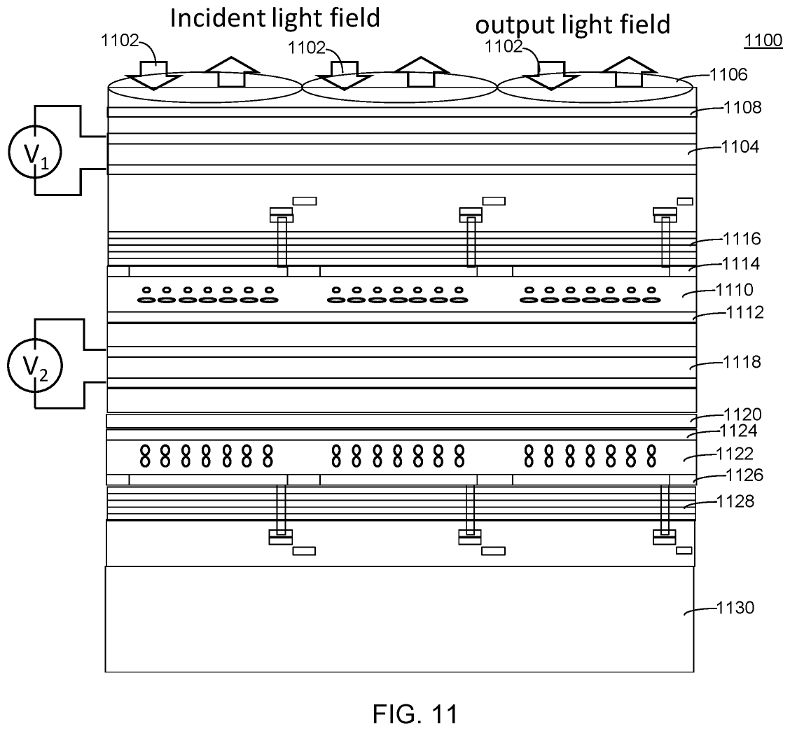

FIG. 11 illustrates a diagram of an example configurable multifunctional display panel 1100 implementing the configurable multifunctional display panel 1000 of FIG. 10, according to an example. An incident light field 1102 may impinge upon a switchable polarization optical element 1104. In some examples, the switchable polarization optical element 1104 may be to place the configurable multifunctional display panel 1100 in one of multiple modes of operation. The switchable polarization optical element 1104 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 1104 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, a focusing element array 1106 may focus light onto openings of the switchable polarization optical element 1104 to increase transmission. The focusing element array 1106 may include one or more of a micro-lens array (MLA), holographic-optic elements (HOE), diffractive-optic elements (DOE), and/or meta-surface elements or arrays.

In some examples, an entrance polarizer 1108 may set a polarization state of the incident light field 1102. For example, the entrance polarizer 1108 may set the polarization state of the incident light 1102 into a well-defined polarization state (e.g., a polarization state PS1 corresponding to horizontal polarization).

In some examples, a polarization-dependent phase modulation layer 1110 modulates at least one of a phase or an amplitude of the light field output by the switchable polarization optical element 1104 as a function of its polarization state. The polarization state may correspond to an operational mode of the configurable multifunctional display panel 1100. For example, one polarization state may correspond to a complex modulation mode, while another polarization state may correspond to a high dynamic range modulation mode.

Operation of the polarization-dependent phase modulation layer 1110 may be controlled by electrodes. For example, a common electrode layer 1112 and pixelated electrodes 1114 may allow individual pixels of the polarization-dependent phase modulation layer 1110 to be controlled. The common electrode layer 1112 and the pixelated electrodes 1114 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides. In some examples, an anti-reflection film 1116 reduces the amount of unwanted or extraneous reflected light that is received by the polarization-dependent phase modulation layer 1110. Reducing the amount of unwanted or extraneous reflected light received by the polarization-dependent phase modulation layer 1110 may reduce the incidence of ghost optical paths, potentially improving contrast performance, light efficiency, and other performance characteristics of the display panel.

In some examples, a switchable polarization optical element 1118 converts the polarization state of the light field output by the polarization-dependent phase modulation layer 1110. The switchable polarization optical element 1118 may be to place the configurable multifunctional display panel 1100 in one of multiple modes of operation. The switchable polarization optical element 1118 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 1118 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

An intermediate polarizer 1120 may set a polarization state of the light field output by the polarization-dependent phase modulation layer 1110 before it is input to an amplitude modulation layer 1122. The light field output after the intermediate polarizer 1120 may have a polarization state PS4 (e.g., corresponding to horizontal polarization). The intermediate polarizer 1120 may be set to transmit light having a polarization state PS4.

In some examples, the amplitude modulation layer 1122 receives light having a polarization state PS4 (e.g., horizontal polarization). In a mode of operation, the amplitude modulation layer 1122 may modify the intensity of light of polarization state PS4 as it reflects off a reflective back panel and passes through the amplitude modulation layer 1122 again. The amplitude modulation layer 1122 may be implemented using any of a variety of materials, including, but not limited to, one or more of the following: liquid crystal under various display modes (e.g., twisted-nematic (TN), in-plane-switching (IPS), fringe field switching (FFS), etc.), active electro-optic polymers, semiconductors, doped materials, active metamaterials (e.g., composite materials having a feature size comparable to or smaller than an operating optical wavelength), and/or optical movable microelectromechanical systems (MEMS) structures. Reflective layers may be added to the sides of the amplitude modulation layer 1122 to form an optical resonance cavity to enhance light-matter interaction.

Operation of the amplitude modulation layer 1122 may be controlled by electrodes. For example, a common electrode layer 1124 and pixelated electrodes 1126 may allow individual pixels of the amplitude modulation layer 1122 to be controlled. The common electrode layer 1124 and the pixelated electrodes 1126 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides. In some examples, an anti-reflection film 1128 reduces the amount of unwanted or extraneous reflected light that is output by the amplitude modulation layer 1122. Reducing the amount of unwanted or extraneous reflected light output by the amplitude modulation layer 1122 may reduce the incidence of ghost optical paths, potentially improving contrast performance, light efficiency, and other performance characteristics of the display panel. The amplitude modulation layer 1122 may be supported on a reflective substrate 1130, such as a reflective back panel.

The configurable multifunctional display panel 1100 may be operated in a first mode corresponding to a base setting. In the base setting, the entrance polarizer 1108 may be set to pass incident light having a polarization state PS1 (e.g., horizontal polarization). The polarization-dependent phase modulation layer 1110 may modify the phase of light with a polarization state PS2 (e.g., horizontal polarization) and may have a different phase response on an orthogonal polarization state PS3 (e.g., vertical polarization). For example, the polarization-dependent phase modulation layer 1110 may have no response or a very small or very large response on polarization state PS3. In some examples, the intermediate polarizer 1120 is set to pass polarization state PS4 (e.g., horizontal polarization).

The amplitude modulation layer 1122 and the intermediate polarizer 1120 may be set to modify the intensity of light of polarization state PS4 when it passes through the structure and is reflected off the reflective substrate 1130. In some examples, static polarization optics elements may be placed between the intermediate polarizer 1120 and the reflective substrate 1130.

The configurable multifunctional display panel 1100 may be operated in a second mode corresponding to a complex modulation mode. The complex modulation mode may be employed in holography. In the complex modulation mode, the switchable polarization optical element 1104 may be set to a first mode (e.g., SPOE-1-Mode-1) such that the polarization state of the incident light is modified from polarization state PS1 to polarization state PS2. The switchable polarization optical element 1118 may be set to a first mode (e.g., SPOE-2-Mode-1) such that the polarization state of light output by the polarization-dependent phase modulation layer 1110 is converted to polarization state PS4 so that transmission through the intermediate polarizer 1120 is maximized.

The configurable multifunctional display panel 1100 may be operated in a third mode corresponding to a double amplitude modulation (e.g., high dynamic range) mode. In the double amplitude modulation mode, the switchable polarization optical element 1104 may be set to a second mode (e.g., SPOE-1-Mode-2) such that the polarization state of the incident light 1102 is modified from the polarization state PS1 to a polarization state PS5 that has equal power in polarization states PS2 and PS3 (e.g., horizontal polarization and vertical polarization, respectively, or 45-degree linear polarization). The switchable polarization optical element 1118 may be set to a second mode (e.g., SPOE-2-Mode-2) such that an input light having polarization state PS2 is converted to a polarization state PS6 that has half of its power in polarization state PS4. An input light having polarization state PS3 is converted to a polarization state PS7 that also has half of its power in polarization state PS4.

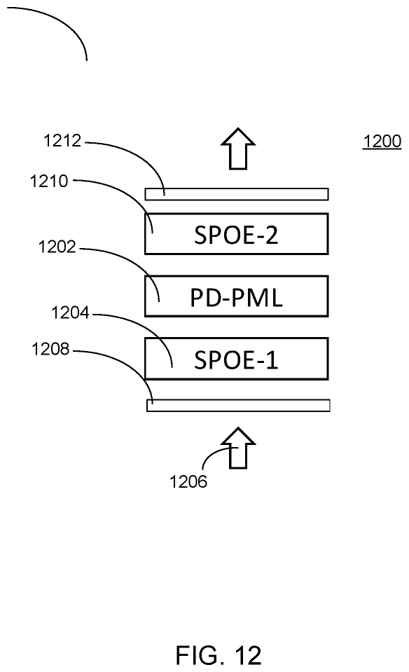

FIG. 12 illustrates a diagram of a configurable multifunctional display panel 1200, according to an example. FIG. 12 illustrates selected functional components of the configurable multifunctional display panel 1200. For simplicity, some material layers, such as a spacer, electrodes, static polarization optics, a micro-lens array, and the like, are not shown in FIG. 12.

In some examples, the configurable multifunctional display panel 1200 may include a polarization-dependent phase modulation layer 1202. A switchable polarization optical element 1204 may selectively modify a polarization state of an incident light field 1206. An entrance polarizer 1208 may be located on a first side of the switchable polarization optical element 1204. The entrance polarizer 1208 may be set to transmit light having a polarization state PS1 (e.g., horizontal polarization). The polarization-dependent phase modulation layer 1202 may modify the phase of light having a polarization state PS2 (e.g., horizontal polarization).

In some examples, a switchable polarization optical element 1210 converts the polarization state of the light field output by the polarization-dependent phase modulation layer 1202. An exit polarizer 1212 may be set to transmit light having a given polarization state PS4 (e.g., horizontal polarization).

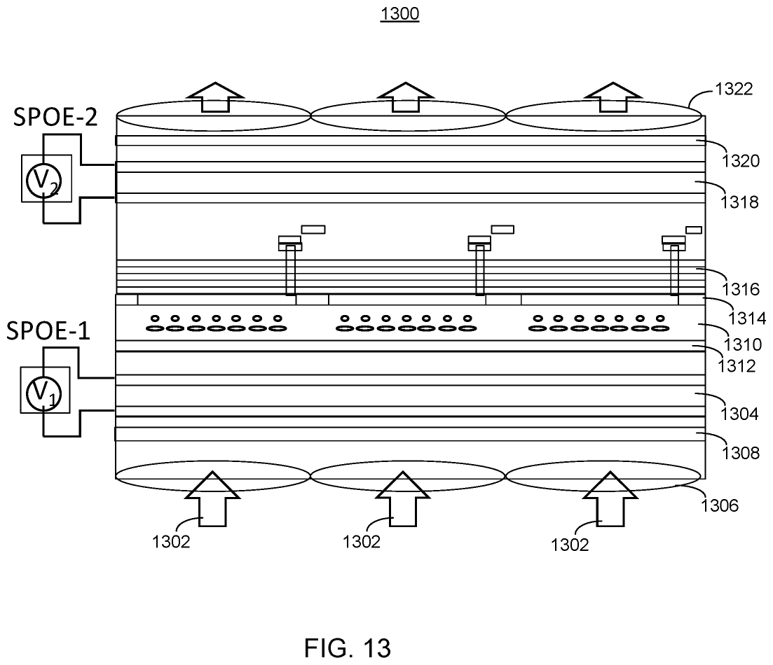

FIG. 13 illustrates a diagram of an example configurable multifunctional display panel 1300 implementing the configurable multifunctional display panel 1200 of FIG. 12, according to an example. An incident light field 1302 may impinge upon a switchable polarization optical element 1304. In some examples, the switchable polarization optical element 1304 may be to place the configurable multifunctional display panel 1300 in one of multiple modes of operation. The switchable polarization optical element 1304 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 1304 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, a focusing element array 1306 may focus light onto openings of the switchable polarization optical element 1304 to increase transmission. The focusing element array 1306 may include one or more of a micro-lens array (MLA), holographic-optic elements (HOE), diffractive-optic elements (DOE), and/or meta-surface elements or arrays.

In some examples, an entrance polarizer 1308 may set a polarization state of the incident light field 1302. For example, the entrance polarizer 1308 may set the polarization state of the incident light field 1302 to a well-defined polarization state (e.g., a polarization state PS1 corresponding to horizontal polarization).

In some examples, a polarization-dependent phase modulation layer 1310 modulates at least one of a phase or an amplitude of the light field output by the switchable polarization optical element 1304 as a function of its polarization state. The polarization state may correspond to an operational mode of the configurable multifunctional display panel 1300. For example, one polarization state may correspond to a complex modulation mode, while another polarization state may correspond to a high dynamic range modulation mode.

Operation of the polarization-dependent phase modulation layer 1310 may be controlled by electrodes. For example, a common electrode layer 1312 and pixelated electrodes 1314 may allow individual pixels of the polarization-dependent phase modulation layer 1310 to be controlled. The common electrode layer 1312 and the pixelated electrodes 1314 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides. In some examples, an anti-reflection film 1316 reduces the amount of unwanted or extraneous reflected light that is received by the polarization-dependent phase modulation layer 1310. Reducing the amount of unwanted or extraneous reflected light received by the polarization-dependent phase modulation layer 1310 may reduce the incidence of ghost optical paths, potentially improving contrast performance, light efficiency, and other performance characteristics of the display panel.

In some examples, a switchable polarization optical element 1318 converts the polarization state of the light field output by the polarization-dependent phase modulation layer 1310. The switchable polarization optical element 1318 may be to place the configurable multifunctional display panel 1300 in one of multiple modes of operation. The switchable polarization optical element 1318 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 1318 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

An exit polarizer 1320 may set a polarization state of the light field output by the switchable polarization optical element 1318. The light field output after the exit polarizer 1320 may have a polarization state PS4 (e.g., corresponding to horizontal polarization).

In some examples, a focusing element array 1322 may focus light that exits the configurable multifunctional display panel 1300. The focusing element array 1322 may include one or more of a micro-lens array (MLA), holographic-optic elements (HOE), diffractive-optic elements (DOE), and/or meta-surface elements or arrays.

The configurable multifunctional display panel 1300 may be operated in a first mode corresponding to a base setting. In the base setting, the entrance polarizer 1308 may be set to transmit light having a polarization state PS1 (e.g., horizontal polarization). In some examples, the entrance polarizer 1308 may be omitted. The polarization-dependent phase modulation layer 1310 may modify the phase of light with a polarization state PS2 (e.g., horizontal polarization) and may have a different phase response (e.g., no response, a very small response, or a very large response) on an orthogonal polarization state PS3 (e.g., vertical polarization). In some examples, the exit polarizer 1320 may be set to transmit light having a polarization state PS4 (e.g., horizontal polarization).

The configurable multifunctional display panel 1300 may be operated in a second mode corresponding to a complex modulation mode. The complex modulation mode may be employed in holography. In the complex modulation mode, the switchable polarization optical element 1304 may be set to a first mode (e.g., SPOE-1-Mode-1) such that the polarization state of light is modified from the polarization state PS1 (e.g., horizontal polarization) to the polarization state PS2 (e.g., horizontal polarization) before the light enters the polarization-dependent phase modulation layer 1310. The switchable polarization optical element 1318 may be set to a first mode (e.g., SPOE-2-Mode-1) such that the polarization state of light output by the polarization-dependent phase modulation layer 1310 is converted to have the polarization state PS4 (e.g., horizontal polarization).

The configurable multifunctional display panel 1300 may be operated in a third mode corresponding to a double amplitude modulation (e.g., high dynamic range) mode. In the double amplitude modulation mode, the switchable polarization optical element 1304 may be set to a second mode (e.g., SPOE-1-Mode-2) such that the polarization state of light is modified from the polarization state PS1 (e.g., horizontal polarization) to a polarization state PS6 that has equal power in polarization states PS2 and PS3 (e.g., horizontal polarization and vertical polarization, respectively, or 45-degree linear polarization). The switchable polarization optical element 1318 may be set to a second mode (e.g., SPOE-2-Mode-2) such that the polarization state of an input light having a polarization state PS2 is converted to have a polarization state PS5 that has half of its power in polarization state PS4. An input light having a polarization state PS3 is converted to have a polarization state PS6 that has half of its power in polarization state PS4 (e.g., horizontal polarization).

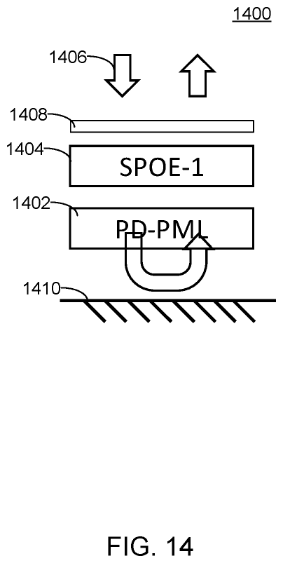

FIG. 14 illustrates a diagram of a configurable multifunctional display panel 1400, according to an example. FIG. 14 illustrates selected functional components of the configurable multifunctional display panel 1400. For simplicity, some material layers, such as a spacer, electrodes, static polarization optics, a micro-lens array, and the like, are not shown in FIG. 14.

In some examples, the configurable multifunctional display panel 1400 may include a polarization-dependent phase modulation layer 1402. A switchable polarization optical element 1404 may selectively modify a polarization state of an incident light field 1406. An entrance polarizer 1408 may be located on a first side of the switchable polarization optical element 1404. The entrance polarizer 1408 may be set to transmit light having a polarization state PS1 (e.g., horizontal polarization). The polarization-dependent phase modulation layer 1402 may modify the phase of light having a polarization state PS2 (e.g., horizontal polarization).

In a complex modulation mode, the switchable polarization optical element 1404 may modify the polarization state of downward-propagating light from polarization state PS1 to polarization state PS2. The light may maintain its polarization state PS2 as it reflects off a back panel 1410 and passes through the polarization-dependent phase modulation layer 1402 again.

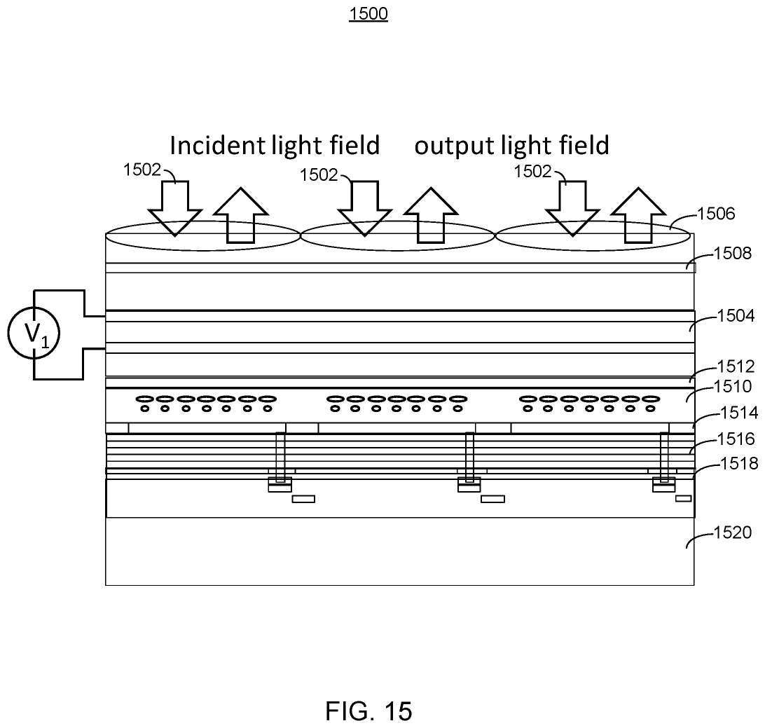

FIG. 15 illustrates a diagram of an example configurable multifunctional display panel 1500 implementing the configurable multifunctional display panel 1400 of FIG. 14, according to an example. An incident light field 1502 may impinge upon a switchable polarization optical element 1504. In some examples, the switchable polarization optical element 1504 may be to place the configurable multifunctional display panel 1500 in one of multiple modes of operation. The switchable polarization optical element 1504 may be implemented using any of a variety of materials, including, but not limited to, one or more of the following: liquid crystal (e.g., twisted-nematic (TN), in-plane-switching (IPS), fringe field switching (FFS), etc.), electro-optic polymers or other types of soft material, electro-optic solid-state material, electro-piezo material, and/or deformable material. The material or materials may be arranged into any of a variety of forms, including, but not limited to, one or more of the following: homogeneous layer(s), random composite material, metamaterial (e.g., composite materials having a feature size comparable to or smaller than an operating optical wavelength), gratings or sub-wavelength gratings, and/or patterned layers.

Operation of the switchable polarization optical element 1504 may be controlled by electrodes, e.g., electrode layers. The electrode layers may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, a focusing element array 1506 may focus light onto openings of the switchable polarization optical element 1504 to increase transmission. The focusing element array 1506 may include one or more of a micro-lens array (MLA), holographic-optic elements (HOE), diffractive-optic elements (DOE), and/or meta-surface elements or arrays.

In some examples, an entrance polarizer 1508 may set a polarization state of the incident light field 1502. For example, the entrance polarizer 1108 may set the polarization state of the incident light 1502 to a well-defined polarization state (e.g., a polarization state PS1 corresponding to horizontal polarization).

In some examples, a polarization-dependent phase modulation layer 1510 modulates at least one of a phase or an amplitude of the light field output by the switchable polarization optical element 1504 as a function of its polarization state. The polarization state may correspond to an operational mode of the configurable multifunctional display panel 1500. For example, one polarization state may correspond to a complex modulation mode, while another polarization state may correspond to a high dynamic range modulation mode.

Operation of the polarization-dependent phase modulation layer 1510 may be controlled by electrodes. For example, a common electrode layer 1512 and pixelated electrodes 1514 may allow individual pixels of the polarization-dependent phase modulation layer 1510 to be controlled. The common electrode layer 1512 and the pixelated electrodes 1514 may be implemented using any of a variety of materials, including, but not limited to, one or more of the following: indium tin oxide (ITO), metal, structured metal grids, conducting polymers, aluminum zinc oxide (AZO), dielectric metal dielectric (DMD), silver nanowire, and/or transparent conductive oxides.

In some examples, the configurable multifunctional display panel 1500 may include a high reflection layer 1516 and/or a metallic reflective layer 1518. When the configurable multifunctional display panel 1500 is operated in a complex modulation mode, the polarization state of downward-propagating light may be modified from polarization state PS1 to polarization state PS2. The light is reflected off the high reflection layer 1516, the metallic reflective layer 1518, and/or a reflective back panel 1520 and maintains the same polarization state PS2 as it passes upward through the polarization-dependent phase modulation layer 1510.

The configurable multifunctional display panel 1500 may be operated in a first mode corresponding to a base setting. In the base setting, the entrance polarizer 1508 may be set to pass incident light having a polarization state PS1 (e.g., horizontal polarization). The polarization-dependent phase modulation layer 1510 may modify the phase of light with a polarization state PS2 (e.g., horizontal polarization) and may have a different phase response on an orthogonal polarization state PS3 (e.g., vertical polarization). For example, the polarization-dependent phase modulation layer 1510 may have no response or a very small or very large response on polarization state PS3.

The configurable multifunctional display panel 1500 may be operated in a second mode corresponding to a complex modulation mode. The complex modulation mode may be employed in holography. In the complex modulation mode, the switchable polarization optical element 1504 may be set to a first mode (e.g., SPOE-1-Mode-1) such that the polarization state of the downward-propagating light is modified from polarization state PS1 to polarization state PS2. The reflected light may maintain the same polarization state PS2 as it reflects off the reflective back panel 1520 and passes through the polarization-dependent phase modulation layer 1510 again.

The configurable multifunctional display panel 1500 may be operated in a third mode corresponding to a double amplitude modulation (e.g., high dynamic range) mode. In the double amplitude modulation mode, the switchable polarization optical element 1504 may be set to a second mode (e.g., SPOE-1-Mode-2) such that the polarization state of the incident light 1502 is modified from the polarization state PS1 to a polarization state PS4 that has equal power in polarization states PS2 and PS3 (e.g., horizontal polarization and vertical polarization, respectively, or 45-degree linear polarization).

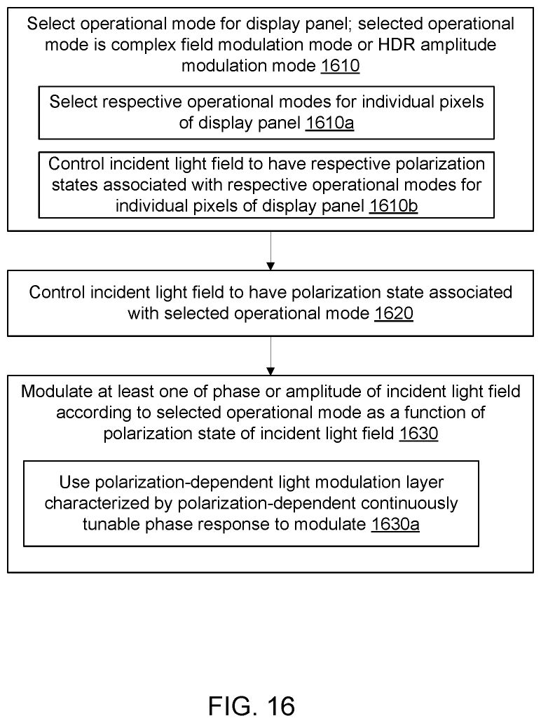

FIG. 16 is a flow diagram illustrating an example method 1600 for modulating light, according to various examples. Briefly, in various examples, the method 1600 may include selecting an operational mode fora display panel. The selected operational mode is one of a complex field modulation mode or a high dynamic range amplitude modulation mode. An incident light field may be controlled to have a polarization state associated with the selected operational mode. At least one of a phase or an amplitude of the incident light field may be modulated according to the selected operational mode as a function of the polarization state of the incident light field.

As represented by block 1610, in various examples, the method 1600 may include selecting an operational mode fora display panel. The selected operational mode is one of a complex field modulation mode or a high dynamic range amplitude modulation mode. As represented by block 1610a, in some examples, the method 1600 includes selecting respective operational modes for individual pixels of the display panel. As described herein, pixelated electrodes allow response characteristics of individual pixels of the display panel to be controlled. For example, some pixels may be set to operate in a complex modulation mode, while other pixels may be set to operate in a double amplitude modulation mode. As represented by block 1610b, the method 1600 may include controlling the incident light field to have respective polarization states associated with the respective operational modes for the individual pixels of the display panel.

As represented by block 1620, in various examples, the method 1600 may include controlling an incident light field to have a polarization state associated with the selected operational mode. As described herein, switchable polarization optical element may be used to control the polarization state of light fields.

As represented by block 1630, in various examples, the method 1600 may include modulating at least one of a phase or an amplitude of the incident light field according to the selected operational mode as a function of the polarization state of the incident light field. As described herein, a polarization-dependent phase modulation layer may be used to modulate the phase and/or the amplitude of light fields. Operation of the polarization-dependent phase modulation layer may be controlled by manipulation of polarization states of light fields. As represented by block 1630a, in some examples, using a polarization-dependent light modulation layer characterized by a polarization-dependent continuously tunable phase response to modulate at least one of a phase or an amplitude of the incident light field according to the selected operational mode.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A display panel, comprising:
a polarization-dependent light modulation layer to modulate at least a phase of an incident light and to generate a modulated light, wherein the modulated light is a function of at least one of a polarization state, a phase, or an amplitude of the incident light; and
one or more switchable polarization optical elements operatively coupled to the polarization-dependent optical modulation layer, wherein the switchable polarization optical element is to select an operational mode of the display panel to by adjusting the polarization state of the incident light to select the modulation applied to the incident light to generate the modulated light.

2. The display panel of claim 1, wherein the polarization-dependent light modulation layer is characterized by a polarization-dependent continuously is tunable phase response for transmitted light.

3. The display panel of claim 1, wherein the polarization-dependent light modulation layer is to place the display panel in a complex modulation mode when the switchable polarization optical element outputs light having a first polarization state.

4. The display panel of claim 1, wherein the polarization-dependent light modulation layer is to place the display panel in a high dynamic range display mode when the switchable polarization optical element outputs light having a second polarization state.

5. The display panel of claim 1, wherein the polarization-dependent light modulation layer is to place the display panel in a phase modulation mode when the switchable polarization optical element outputs light having a first polarization state.

6. The display panel of claim 1, wherein the polarization-dependent light modulation layer is to place the display panel in an amplitude modulation mode when the switchable polarization optical element outputs light having a second polarization state.

7. The display panel of claim 1, further comprising a polarizer operatively coupled to the switchable polarization optical element, wherein the polarizer is to permit passage of light having a selected polarization state.

8. The display panel of claim 1, further comprising a focusing element array operatively coupled to the polarization-dependent light modulation layer, wherein the focusing element array is to increase transmission of light to the polarization-dependent light modulation layer.

9. A near-eye display device, comprising:
a polarization-dependent light modulation layer to modulate at least a phase of an incident light and to generate a modulated light, wherein the modulated light is a function of at least one of a polarization state, a phase, or an amplitude of the incident light; and
one or more switchable polarization optical elements operatively coupled to the polarization-dependent optical modulation layer, wherein the switchable polarization optical element is to select an operational mode of the display panel to by adjusting the polarization state of the incident light to select the modulation applied to the incident light to generate the modulated light.

10. The near-eye display device of claim 9, wherein the polarization-dependent light modulation layer is characterized by a polarization-dependent continuously tunable phase response for transmitted light.

11. The near-eye display device of claim 9, wherein the polarization-dependent light modulation layer is to place the display panel in a complex modulation mode when the switchable polarization optical element outputs light having a first polarization state.

12. The near-eye display device of claim 9, wherein the polarization-dependent light modulation layer is to place the display panel in a high dynamic range display mode when the switchable polarization optical element outputs light having a second polarization state.

13. The near-eye display device of claim 9, wherein the polarization-dependent light modulation layer is to place the display panel in a phase modulation mode when the switchable polarization optical element outputs light having a first polarization state.

14. The near-eye display device of claim 9, wherein the polarization-dependent light modulation layer is to place the display panel in an amplitude modulation mode when the switchable polarization optical element outputs light having a second polarization state.

15. The near-eye display device of claim 9, further comprising a polarizer operatively coupled to the switchable polarization optical element, wherein the polarizer is to permit passage of light having a selected polarization state.

16. The near-eye display device of claim 9, further comprising a focusing element array operatively coupled to the polarization-dependent light modulation layer, wherein the focusing element array is to increase transmission of light to the polarization-dependent light modulation layer.

17. A method for modulating light, the method comprising:
selecting an operational mode for a display panel, wherein the selected operational mode is one of a complex field modulation mode or a high dynamic range amplitude modulation mode;
controlling an incident light to have a polarization state associated with the selected operational mode; and
modulating at least one of a phase or an amplitude of the incident light according to the selected operational mode as a function of the polarization state of the incident light.

18. The method of claim 17, further comprising using a polarization-dependent light modulation layer characterized by a polarization-dependent continuously tunable phase response to modulate at least one of a phase or an is amplitude of the incident light according to the selected operational mode.

19. The method of claim 17, further comprising selecting respective operational modes for individual pixels of the display panel.

20. The method of claim 19, further comprising controlling the incident light to have respective polarization states associated with the respective operational modes for the individual pixels of the display panel.
